(19) United States
(12) Patent Application Publication
(10) Pub. No.: US 2015/0372726 A1
(43) Pub. Date: Dec. 24, 2015

(54) ITERATIVE INTERFERENCE ALIGNMENT (IA) METHOD AND APPARATUS FOR PERFORMING DOWNLINK MULTI-USER MULTIPLE-INPUT AND MULTIPLE-OUTPUT (DL MU-MIMO) COMMUNICATION

(71) Applicant: ELECTRONICS AND TELECOMMUNICATIONS RESEARCH INSTITUTE, Daejeon (KR)

(72) Inventors: Min Ho CHEONG, Daejeon (KR); Hyoung Jin KWON, Daejeon (KR); Sok Kyu LEE, Daejeon (KR); Jae Seung LEE, Daejeon (KR)

(21) Appl. No.: 14/748,000

(22) Filed: Jun. 23, 2015

(30) Foreign Application Priority Data
Jun. 24, 2014 (KR) 10-2014-0077334

(51) Int. Cl. H04B 7/04; H04B 15/00

(52) U.S. Cl. CPC H04B 7/0452; H04B 15/00

(57) ABSTRACT

Provided is an iterative interference alignment (IA) method and apparatus for performing a downlink multi-user multiple-input and multiple-output (DL MU-MIMO), including transmitting, to a user terminal, a transmission beamforming vector generated arbitrarily, receiving, from the user terminal, a reception beamforming vector calculated to minimize interference based on the transmission beamforming vector, and updating the transmission beamforming vector based on the reception beamforming vector, the iterative IA method may further include calculating a transmission beamforming vector space minimizing interference of an inter-basic service set based on the reception beamforming vector, calculating a transmission beamforming matrix minimizing interference of an intra-basic service set, based on the reception beamforming vector, and updating the transmission beamforming vector based on the transmission beamforming matrix and the transmission beamforming vector space.

### CROSS-REFERENCE TO RELATED APPLICATION

This application claims the priority benefit of Korean Patent Application No. 10-2014-0077334, filed on Jun. 24, 2014, in the Korean Intellectual Property Office, the disclosure of which is incorporated herein by reference.

### BACKGROUND

1. Field of the Invention

Example embodiments of the present invention relate to a method of performing a downlink multi-user multiple-input and multiple-output (DL MU-MIMO) communication based on an iterative interference alignment (IA) scheme, and more particularly, to a method and apparatus for updating a transmission beamforming vector to control power of the transmission beamforming vector.

2. Description of the Related Art

An opportunistic interference alignment (OIA) may be performed based on a multi-user diversity. Accuracy of the OIA may increase according to an increase in a number of user terminals. Thus, a plurality of user terminals may need to be present in each basic service set (BSS) to achieve at least a predetermined level of throughput. When a relatively small number of user terminals is present in each BSS, an interference alignment (IA) may not be performed based on the OIA only. In this example, beamforming may need to be performed in consideration of an inter-channel between a transmitter and a receiver to perform the IA with an increased efficiency.

Thus, when the relatively small number of user terminal is present in each BSS, the IA may be more efficiently performed based on an iterative IA. In general, the iterative IA may be performed based on a K-user interference channel. Also, the IA may be performed with a reduced efficiency when the iterative IA is applied to an environment of the MU-MIMO communication.

Accordingly, there is desire for an iterative IA method that may also derive a high throughput in an environment of the DL MU-MIMO communication.

### SUMMARY

An aspect of the present invention provides a method and apparatus for efficiently lo performing an interference alignment (IA) in an environment of a downlink multi-user multiple-input and multiple-output (DL MU-MIMO) communication by updating a transmission beamforming vector based on interference of an inter-basic service set and interference of an intra-basic service set.

Another aspect of the present invention also provides a method and apparatus for efficiently performing an IA by controlling power of a transmission beamforming vector despite an environmental factor, for example, a relatively great number of interfering basic service sets (BSSs) and a relatively small number of communication apparatuses or user terminals.

According to an aspect of the present invention, there is provided an IA method including transmitting, to a user terminal, a transmission beamforming vector generated arbitrarily, receiving, from the user terminal, a reception beamforming vector calculated to minimize interference based on the transmission beamforming vector, and updating the transmission beamforming vector based on the reception beamforming vector.

The updating may include calculating a transmission beamforming vector space minimizing interference of an inter-basic service set based on the reception beamforming vector, calculating a transmission beamforming matrix minimizing interference of an intra-basic service set, based on the reception beamforming vector, and updating the transmission beamforming vector based on the transmission beamforming matrix and the transmission beamforming vector space.

The calculating of the space may include calculating the transmission beamforming vector space using eigenvectors corresponding to eigenvalues of an interference vector calculated based on the reception beamforming vector.

The calculating of the transmission beamforming matrix may include calculating the transmission beamforming matrix such that the transmission beamforming vector is removed in response to the transmission beamforming vector received and decoded by a user terminal unpaired with a communication apparatus transmitting the transmission beamforming vector.

The receiving and the updating may be iteratively performed a preset number of times or until the transmission beamforming vector or the reception beamforming vector converges.

The method may further include controlling power of the transmission beamforming vector based on a leakage of interference (LIF) of the user terminal.

The controlling may include increasing the power of the transmission beamforming vector in a case in which an interference level of the transmission beamforming vector is less than a preset threshold, or in a case in which a throughput efficiency of the transmission beamforming vector is greater than the preset threshold.

The LIF may be shared with another communication apparatus within a network by broadcasting, to the other communication apparatus, a level of interference occurring due to the transmission beamforming vector.

According to another aspect of the present invention, there is also provided an IA method including receiving a transmission beamforming vector from a communication apparatus, updating a reception beamforming vector based on the transmission beamforming vector, and transmitting the reception beamforming vector to the communication apparatus, wherein the transmission beamforming vector is updated based on the reception beamforming vector.

The transmission beamforming vector may be updated based on a transmission beamforming vector space calculated based on the reception beamforming vector and minimizing interference of an inter-basic service set, and a transmission beamforming matrix calculated based on the reception beamforming vector and minimizing interference of an intra-basic service set.

According to still another aspect of the present invention, there is also provided a communication apparatus including a transmitter to transmit, to a user terminal, a transmission beamforming vector generated arbitrarily, a receiver to receive, from the user terminal, a reception beamforming vector calculated to minimize interference based on the transmission beamforming vector, and an updater to update the transmission beamforming vector based on the reception beamforming vector.

The updater may include a first calculator to calculate a transmission beamforming vector space minimizing interference of an inter-basic service set based on the reception beamforming vector, a second calculator to calculate a transmission beamforming matrix minimizing interference of an intra-basic service set based on the reception beamforming vector, and a transmission beamforming vector unit to update the transmission beamforming vector based on the transmission beamforming matrix and the transmission beamforming vector space.

The first calculator may calculate the transmission beamforming vector space using eigenvectors corresponding to eigenvalues of an interference vector calculated based on the reception beamforming vector.

The second calculator may calculate the transmission beamforming matrix such that the transmission beamforming vector is removed in response to the transmission beamforming vector received and decoded by a user terminal unpaired with a communication apparatus transmitting the transmission beamforming vector.

The receiver and the updater may iteratively perform functions a preset number of times or until the transmission beamforming vector or the reception beamforming vector converges.

The apparatus may further include a power controller to control power of the transmission beamforming vector based on an LIF of the user terminal.

The power controller may increase the power of the transmission beamforming vector in a case in which an interference level of the transmission beamforming vector is less than a preset threshold, or in a case in which a throughput efficiency of the transmission beamforming vector is greater than the preset threshold.

The LIF may be shared with another communication apparatus within a network by broadcasting, to the other communication apparatus, a level of interference occurring due to the transmission beamforming vector.

According to yet another aspect of the present invention, there is also provided a user terminal including a receiver to receive a transmission beamforming vector from a communication apparatus, an updater to update a reception beamforming vector based on the transmission beamforming vector, and a transmitter to transmit the reception beamforming vector to the communication apparatus, wherein the transmission beamforming vector is updated based on the reception beamforming vector.

The transmission beamforming vector may be updated based on a transmission beamforming vector space calculated based on the reception beamforming vector and minimizing interference of an inter-basic service set, and a transmission beamforming matrix calculated based on the reception beamforming vector and minimizing interference of an intra-basic service set.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a communication system for performing a communication based on an interference alignment (IA) method according to an example embodiment; FIG. 2 illustrates an iterative IA method according to an example embodiment;

FIG. 3 illustrates an IA method of a user terminal and a communication apparatus based on an iterative IA method according to an example embodiment;

FIG. 4 illustrates a method of updating a transmission beamforming vector using a communication apparatus according to an example embodiment;

FIG. 5 illustrates configurations of a communication apparatus and a user terminal according to an example embodiment; and

FIGS. 6 and 7 illustrate sum-rates based on a number of antennas in a user terminal according to an example embodiment.

### DETAILED DESCRIPTION

Hereinafter, the preferred embodiments of the present invention will be described with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out. The following detailed description includes specific details in order to provide a thorough understanding of the present invention. However, it will be apparent to those skilled in the art that the present invention may be practiced without such specific details.

The following technology may be used for various wireless access systems such as code division multiple access (CDMA), frequency division multiple access (FDMA), time division multiple access (TDMA), orthogonal frequency division multiple access (OFDMA), and single carrier frequency division multiple access (SC-FDMA). The CDMA may be implemented by the radio technology such as universal terrestrial radio access (UTRA) or CDMA 2000. The TDMA may be implemented by the radio technology such as global system for mobile communications (GSM)/general packet radio service (GPRS)/enhanced data rates for GSM evolution (EDGE). The OFDMA may be implemented by the radio technology such as IEEE 802.11 (Wi-Fi), IEEE 802.16 (WiMAX), IEEE 802-20, and evolved UTRA (E-UTRA). Although the following description will be based on the IEEE 802.11 system to clarify description of technical features, it is to be understood that technical spirits of the present invention are not limited to the IEEE 802.11 system.

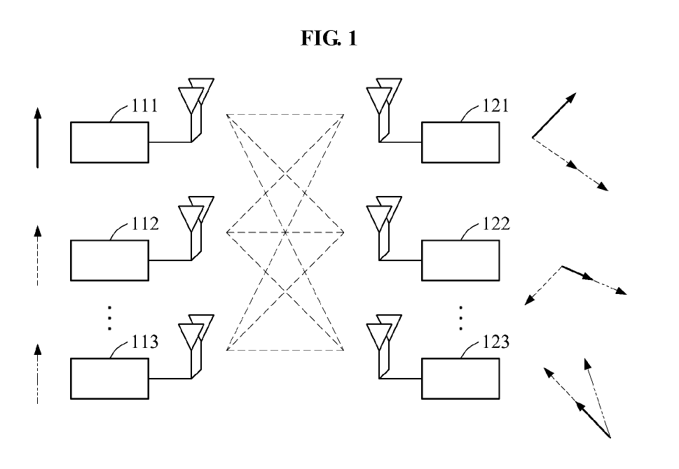

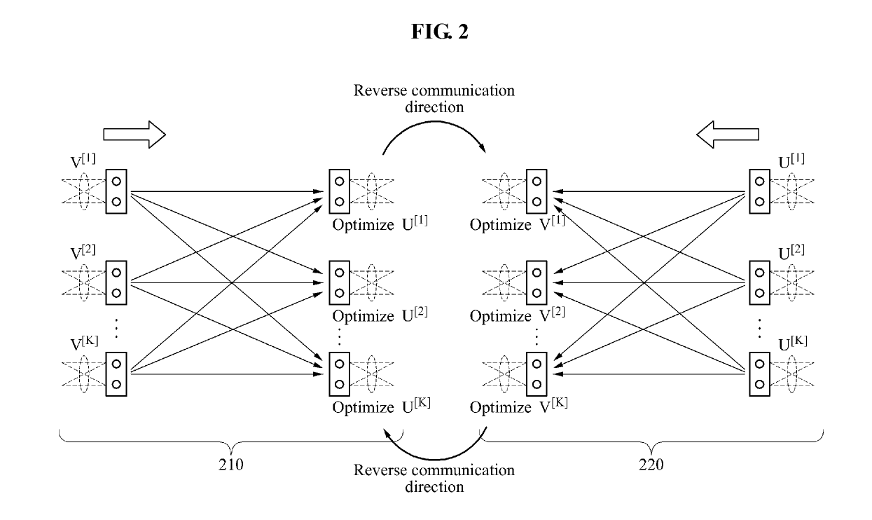

FIG. 1 illustrates a communication system for performing a communication based on an interference alignment (IA) method according to an example embodiment.

The IA scheme may be, for example, a scheme for zero forcing (ZF) by dividing a space of a receiver into two portions in an interfered channel situation, aligning a signal received from a transmitter corresponding to the receiver in one divided portion, and aligning an interference signal received from another transmitter in another divided portion. When the IA scheme is applied to a wireless local area network (WLAN), degrees of freedom (DoF) may increase proportionally to a number of access points (APs) by mapping, to a restricted-dimensional space, interference signals received by each receiver included in an interference network, thereby increasing a sum-rate of an environment of the network.

The communication system for performing a communication based on an IA method according to an example embodiment may perform a multi-user multiple-input and multiple-output (MU-MIMO) communication. The communication system may include a plurality of communication apparatuses, for example, communication apparatuses 111 through 113, and a plurality of user terminals, for example, user terminals 121 through 123. The plurality of communication apparatuses may include Mⱼ antennas, and the plurality of user terminals may include Nⱼ antennas. In this example, a j^{th} communication apparatus may be paired with an i^{th} user terminal, and a communication apparatus may communicate with only a user terminal paired with the communication apparatus.

In this example, the communication apparatus may be configured to transmit data to the user terminal using a downlink and receive the data from the user terminal using an uplink. The communication apparatus may include, for example, an AP and a base station. The user terminal may be configured to communicate with the communication apparatus through a network including the user terminal and may include, for example, a mobile station, a tablet personal computer (PC), a laptop computer, a personal digital assistant (PDA), and a mobile terminal

Each of the plurality of communication apparatuses may communicate with a corresponding user terminal using a unique transmission beamforming vector. The plurality of user terminals may receive a plurality of transmission beamforming vectors from the plurality of communication apparatuses, and perform an IA on the received transmission beamforming vectors. For example, each of the plurality of user terminals may align, in a space, a transmission beamforming vector received from a communication apparatus paired therewith. Also, each of the plurality of user terminals may align, in another space, a transmission beamforming vector received from another communication apparatus.

In this example, the transmission beamforming vector may refer to a vector indicating a direction and intensity of a transmission beam transmitted from the communication apparatus to the user terminal Also, a reception beamforming vector may refer to a vector indicating a direction and intensity of a reception beam received by the user terminal from the communication apparatus.

FIG. 2 illustrates an iterative IA method according to an example embodiment.

An iterative IA may be a scheme for performing an IA using local channel knowledge through channel information transmission performed between the communication apparatus and the user terminal based on a cognitive principle and reciprocity of a channel. In this example, the reciprocity of the channel may indicate that a channel between the communication apparatus and the user terminal is equivalent with respect to an uplink and a downlink.

In operation 210, the communication apparatus generates a predetermined transmission beamforming vector, and transmit the generated transmission beamforming vector to the user terminal The user terminal may receive a plurality of transmission beamforming vectors from a plurality of communication apparatuses, and verify an interference signal from the plurality of transmission beamforming vectors. Also, the user terminal may calculate a reception beamforming vector minimizing an intensity of the verified interference signal.

In operation 220, the user terminal transmits the calculated reception beamforming vector to the communication apparatus. The communication apparatus may receive a plurality of reception beamforming vectors from a plurality of user terminals, and reconstruct the transmission beamforming vector based on the plurality of reception beamforming vectors.

Also in operation 210, the communication apparatus may transmit the reconstructed transmission beamforming vector to the user terminal For example, the communication apparatus may broadcast the reconstructed transmission beamforming vector.

Based on the above scheme, the communication apparatus and the user terminal may update the transmission beamforming vector and the reception beamforming vector until the transmission beamforming vector or the reception beamforming vector converges. Through this, the user terminal may align interference signals included in the transmission beamforming vector received from the communication apparatus, in a predetermined space.

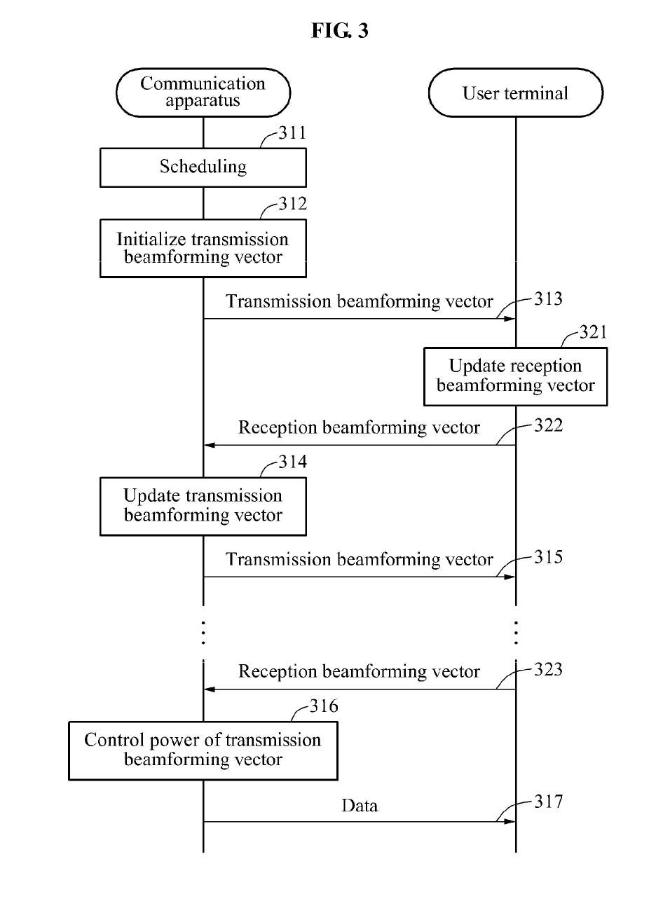

FIG. 3 illustrates an IA method of a user terminal and a communication apparatus based on an iterative IA method according to an example embodiment.

The IA method according to an example embodiment may be performed by a processor included in the user terminal and the communication apparatus.

In operation 311, the communication apparatus performs user scheduling. The communication apparatus may allocate wireless resources to the user terminal

In operation 312, the communication apparatus initializes a transmission beamforming vector. For example, the communication apparatus may arbitrarily generate the transmission beamforming vector.

In operation 313, the communication apparatus transmits the generated transmission beamforming vector to the user terminal In this example, the transmission beamforming vector may be transmitted to a user terminal unpaired with the communication apparatus as well as a user terminal paired with the communication apparatus.

In operation 321, the user terminal updates a reception beamforming vector to minimize interference based on the received transmission beamforming vector. For example, the user terminal may verify an interference signal based on the received transmission beamforming vector, and calculate the reception beamforming vector minimizing the interference based on the verified interference signal.

In detail, the user terminal may calculate a unit vector minimizing interference of an inter-basic service set and interference of an intra-basic service set. The user terminal may update the reception beamforming vector as shown in Equation 1.

$${u}_{g , s} ∈ {C}^{L \times 1} , \\ {arg min}_{{u}_{g , s}} {\sum }_{\begin{matrix}q = 1 \\ q \neq s\end{matrix}}^{S} {\vert {u}_{g , s}^{H} {H}_{g}^{g , s} {V}_{g} {b}_{q} \vert}^{2} + {\sum }_{\begin{matrix}k = 1 \\ k \neq g\end{matrix}}^{K} {‖ {u}_{g , s}^{H} {H}_{k}^{g , s} {T}_{k} ‖}^{2} \qquad [ Equation 1 ]$$

In Equation 1, u_{g,s} denotes a reception beamforming vector for an s^{th} stream of a user terminal included in a g^{th} basic service set (BSS), C^{L×1} denotes L×1 vector dimensions, H_{g}^{g,s} denotes a communication channel for the s^{th} stream transmitted to a communication apparatus of the g^{th} BSS in the g^{th} BSS, V_{g} denotes an orthonormal vector expressing a transmission beamforming vector space from the communication apparatus of the g^{th} BSS, b_{q} denotes a transmission beamforming matrix of a q^{th} stream, and Tₖ denotes a transmission beamforming vector from a communication apparatus of a k^{th} BSS.

Also, in Tₖ=VₖBₖ, Vₖ denotes a vector space formed using the orthonormal vector, and Bₖ denotes Bₖ=[b_{k,1} . . . b_{k,S}]∈C^{S×S} which is a transmission beamforming matrix minimizing the interference of the intra-basic service set.

In Equation 1,

$${\sum }_{\begin{matrix}q = 1 \\ q \neq s\end{matrix}}^{S} {\vert {u}_{g , s}^{H} {H}_{g}^{g , s} {V}_{g} {b}_{q} \vert}^{2}$$

represents an amount of the interference of the intra-basic service set. Also,

$${\sum }_{\begin{matrix}k = 1 \\ k \neq g\end{matrix}}^{K} {‖ {u}_{g , s}^{H} {H}_{k}^{g , s} {T}_{k} ‖}^{2}$$

represents an amount of the interference occurring due to a data transmission of the inter-basic service set.

The reception beamforming vector for minimizing an amount of interference may be calculated based on various methods. In this example, the reception beamforming vector may be calculated through an eigenvalue decomposition.

The user terminal may calculate an interference vector C_{g,s} based on the received transmission beamforming vector as shown in Equation 2.

$${C}_{g , s} = {\sum }_{\begin{matrix}q = 1 \\ q \neq s\end{matrix}}^{S} ( {H}_{g}^{g , s} {V}_{g} {b}_{q} ) {( {H}_{g}^{g , s} {V}_{g} {b}_{q} )}^{H} + {\sum }_{\begin{matrix}k = 1 \\ k \neq g\end{matrix}}^{K} ( {H}_{k}^{g , s} {T}_{k} ) {( {H}_{k}^{g , s} {T}_{k} )}^{H} \qquad [ Equation 2 ]$$

The user terminal may obtain an eigenvalue including a minimum number of items among the eigenvalues of the interference vector C_{g,s}, and calculate an eigenvector corresponding to the obtained eigenvalue. Through this, the user terminal may minimize the amount of interference using the eigenvector corresponding to the eigenvalue including the minimum number of items. Thus, the user terminal may update the reception vector based on the eigenvector corresponding to the eigenvalue including the minimum number of items.

In operation 322, the user terminal transmits the updated reception beamforming vector to the communication apparatus. In this example, the reception beamforming vector may be transmitted to a communication apparatus unpaired with the user terminal as well as a communication apparatus paired with the user terminal.

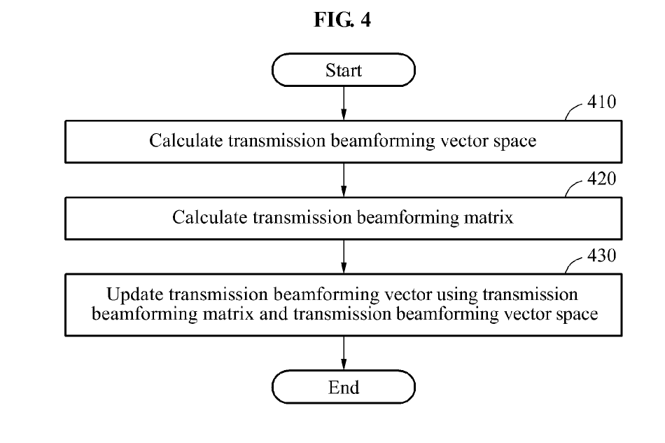

In operation 314, the communication apparatus updates the transmission beamforming vector to minimize the interference based on the reception beamforming vector received from the user terminal Related descriptions about a process of updating the transmission beamforming vector will be provided with reference to FIG. 4.

In operation 315, the communication apparatus transmits the updated transmission beamforming vector to the user terminal.

Operations 321, 322, 314, and 315 may be iteratively performed a preset number of times or until the transmission beamforming vector or the reception beamforming vector converges. For example, operations 321, 322, 314, and 315 may not be unlimitedly iterated due to restrictions on a coherence time of a wireless channel and in an aspect of a frame overhead and thus, a communication system may set a reference for terminating iteration in advance.

In operation 323, the user terminal transmits the reception beamforming vector updated last, to the communication apparatus.

In operation 316, the communication apparatus controls power of the transmission beamforming vector when the reference for terminating the iteration is satisfied.

As an example, when an interference level of the transmission beamforming vector is less than a preset threshold, or when a throughput efficiency of the transmission beamforming vector is greater than the preset threshold, the communication apparatus may increase the power of the transmission beamforming vector. When the aforementioned condition is satisfied, the communication apparatus may increase the power of the transmission beamforming vector to correspond to a preset value or based on a preset ratio.

Conversely, when the interference level of the transmission beamforming vector is greater than the preset threshold, or when the throughput efficiency of the transmission beamforming vector is less than the present threshold, the communication apparatus may reduce the power of the transmission beamforming vector to correspond to the preset level or based on the preset ratio.

For example, the communication apparatus may control the power of the transmission beamforming vector based on a leakage of interference (LIF). The communication apparatus may calculate the LIF as shown in Equation 3.

$$LIF ( g , s ) = {\sum }_{\begin{matrix}k = 1 \\ k \neq g\end{matrix}}^{K} {‖ {u}_{k , s}^{H} {H}_{g}^{k , s} {T}_{g} ‖}^{2} \qquad [ Equation 3 ]$$

In Equation 3, LIF(g, s) denotes an LIF between the g^{th} communication apparatus and the s^{th} user terminal.

The communication apparatus may calculate a level of interference that may be caused by the transmission beamforming vector transmitted by the communication apparatus, and broadcast the calculated level to another communication apparatus included in a communication network. Thus, the communication apparatus may share the LIF with the other communication apparatus.

Also, the communication apparatus may adjust the power of the transmission beamforming vector based on the LIF. P_{g,s} denoting the power of the transmission beamforming vector may be calculated as shown in Equation 4.

$${p}_{g , s} = SNR \frac{{min ( LIF ( a , b ) )}_{a ∈ \{ 1 , 2 , … , K ) , b ∈ \{ 1 , 2 , … , S )}}{LIF ( g , s )} \qquad [ Equation 4 ]$$

By controlling the power of the transmission beamforming vector, an IA may be complementally performed (1) when the number of antennas included in the communication apparatus or the user terminal is relatively small, or (2) when the number of interfering BSSs is relatively large.

In operation 317, the communication apparatus transmits data using the transmission beamforming vector of which the power is controlled.

FIG. 4 illustrates a method of updating a transmission beamforming vector using a communication apparatus according to an example embodiment.

The method of updating a transmission beamforming vector may be performed by a processor included in the communication apparatus.

In operation 410, the communication apparatus calculates a transmission beamforming vector space minimizing interference of an inter-basic service set. For example, the communication apparatus may calculate a space V_{g} of the transmission beamforming vector as shown in Equation 5.

$${V}_{g} ∈ {C}^{M \times S} , min {\sum }_{\begin{matrix}k = 1 \\ k \neq g\end{matrix}}^{K} {\sum }_{s = 1}^{S} {‖ {u}_{k , s}^{H} {H}_{g}^{k , s} {V}_{g} ‖}^{2} \qquad [ Equation 5 ]$$

In Equation 5, M denotes a dimension of a channel transmitted from a communication apparatus of a g^{th} BSS to an s^{th} stream of a k^{th} BSS, S denotes a total number of transmission streams, u_{k,s} denotes a unit vector of a reception beamforming vector for the s^{th} stream of a user terminal included in the k^{th} BSS, and H_{g}^{k,s} denotes a communication channel of the s^{th} stream transmitted from the communication apparatus of the g^{th} BSS to the user terminal of the k^{th} BSS.

The communication apparatus may calculate the transmission beamforming vector space minimizing the interference of the inter-basic service set through an eigenvalue decomposition. The communication apparatus may calculate the transmission beamforming vector space based on the same method as that of obtaining a vector space in the user terminal.

As an example, the communication apparatus may calculate an interference vector based on a reception beamforming vector received from the user terminal. The communication apparatus may obtain a minimum eigenvalue based on eigenvalues of the interference vector, and calculate an eigenvector corresponding to the minimum eigenvalue. Through this, the communication apparatus may set the eigenvector corresponding to the minimum eigenvalue as the transmission beamforming vector space.

In operation 420, the communication apparatus may calculate a transmission beamforming matrix minimizing interference of an intra-basic service set. As an example, the communication apparatus may construct the transmission beamforming matrix such that the transmission beamforming vector is removed, for example, nulled out from a user terminal unpaired with the communication apparatus when the user terminal receives the transmission beamforming vector and decode the received transmission beamforming vector. For example, the communication apparatus may calculate B_{g} denoting the transmission beamforming matrix as shown in Equation 6.

B_{g}=[b_{g,1} . . . b_{g,S}]∈C^{S×S}, such that u_{k,j}^{H}H_{g}^{g,j}V_{g}b_{g,s}=0 for s≠j, [Equation 6]

In Equation 6, b_{g,s} denotes a transmission beamforming vector for the s^{th} stream transmitted from the communication apparatus of the g^{th} BSS, and C^{S×S} denotes a dimension of a complex number matrix having columns and rows corresponding to “S” which is the total number of transmission streams.

In operation 430, the communication apparatus updates the transmission beamforming vector using the transmission beamforming matrix and the transmission beamforming vector space. For example, the communication apparatus may update a transmission beamforming vector T_{g} as shown in Equation 7.

T_{g}=V_{g}B_{g} [Equation 7]

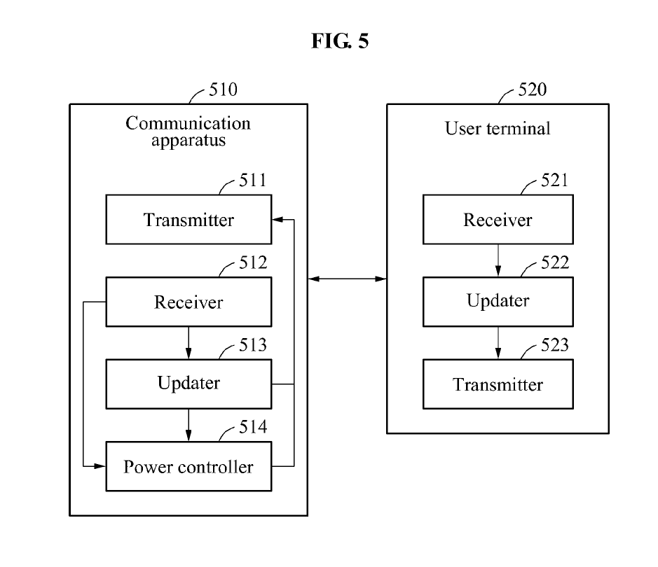

FIG. 5 illustrates configurations of a communication apparatus 510 and a user terminal 520 according to an example embodiment.

A communication system for performing a communication based on an iterative IA method may include a plurality of communication apparatuses and a plurality of user terminals. For increased clarity and conciseness, FIG. 5 illustrates a communication apparatus and a user terminal However, the number of communication apparatuses and the number of user terminals are not limited thereto.

The communication apparatus 510 includes a transmitter 511, a receiver 512, an updater 513, and a power controller 514. In this example, the communication apparatus 510 may be paired with the user terminal 520.

The transmitter 511 may transmit, to the user terminal 520, a transmission beamforming vector generated arbitrarily. The transmitter 511 may transmit an updated transmission beamforming vector to the user terminal 520. Also, the transmitter 511 may transmit data to the user terminal 520 using a transmission beamforming vector of which power is controlled.

The receiver 512 may receive, from the user terminal 520, a reception beamforming vector calculated to minimize interference based on the transmission beamforming vector.

The updater 513 may update the transmission beamforming vector based on the reception beamforming vector received from the receiver 512. For example, the updater 513 may include a first calculator, a second calculator, and a transmission beamforming vector unit.

The first calculator may calculate a transmission beamforming vector space minimizing interference of an inter-basic service set based on the reception beamforming vector. Also, the first calculator may calculate the transmission beamforming vector space using eigenvectors corresponding to eigenvalues of an interference vector calculated based on the reception beamforming vector.

The second calculator may calculate a transmission beamforming matrix minimizing interference of an intra-basic service set based on the reception beamforming vector. Also, the second calculator may calculate the transmission beamforming matrix such that the transmission beamforming vector is nulled when a user terminal unpaired with the communication apparatus 510 transmitting the transmission beamforming vector receives the transmission beamforming vector and decodes the received transmission beamforming vector.

The transmission beamforming vector unit may update the transmission beamforming vector based on the transmission beamforming matrix and the transmission beamforming vector space.

Also, the transmitter 511, the receiver 512, and the updater 513 may iteratively perform functions a preset number of times or until the transmission beamforming vector or the reception beamforming vector converges.

The power controller 514 may control power of the transmission beamforming vector based on an LIF of the user terminal 520. Also, the power controller 514 may increase the power of the transmission beamforming vector when an interference level of the transmission beamforming vector is less than a preset threshold, or when a throughput efficiency of the transmission beamforming vector is greater than the preset threshold. In this example, the LIF may be shared with another communication apparatus included in a network by broadcasting a level of interference caused by the transmission beamforming vector to the other communication apparatus.

The user terminal 520 includes a receiver 521, an updater 522, and a transmitter 523. In this example, the user terminal 520 may be paired with the communication apparatus 510 to perform communication.

The receiver 521 may receive the transmission beamforming vector from the communication apparatus 510. Also, the receiver 521 may receive data from the communication apparatus 510 using the transmission beamforming vector.

The updater 522 may update the reception beamforming vector based on the transmission beamforming vector. The updater 522 may update the reception beamforming vector minimizing interference of an intra-basic service set and the interference of the inter-basic service set.

The transmitter 523 may transmit the reception beamforming vector to the communication apparatus 510.

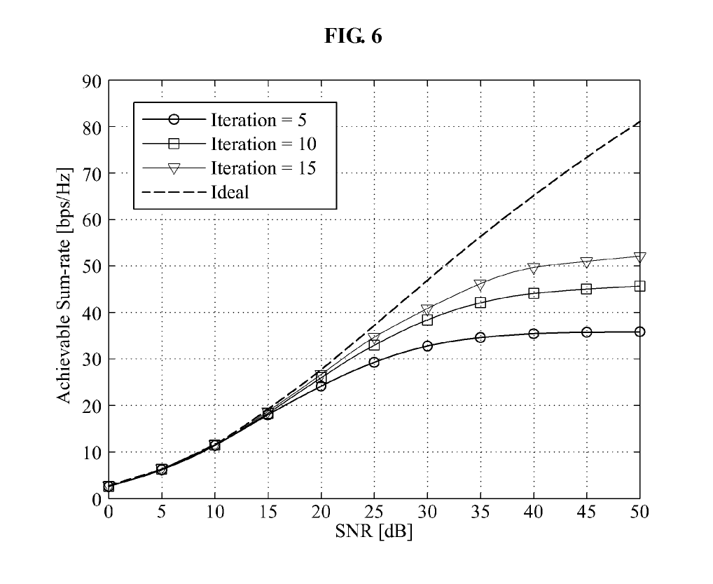

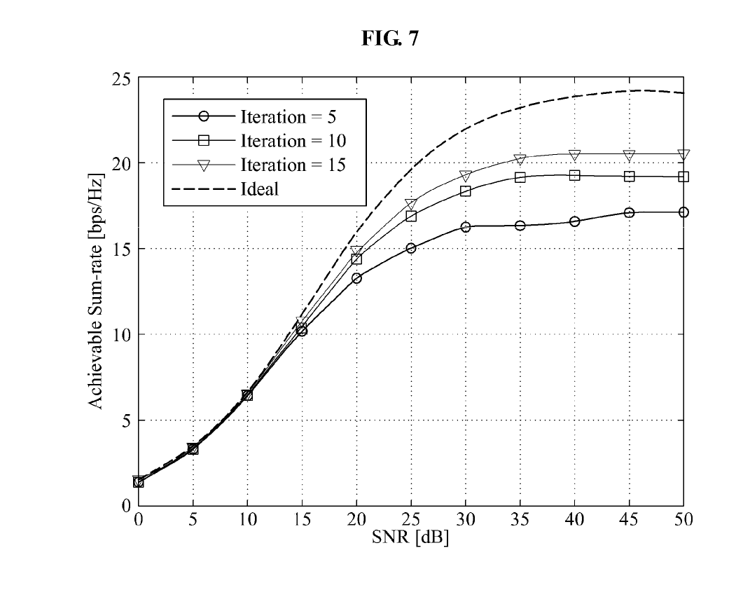

FIGS. 6 and 7 illustrate sum-rates based on a number of antennas in a user terminal according to an example embodiment.

FIGS. 6 through 9 illustrate performance graphs of sum-rates obtained by applying the iterative IA to a DL MU-MIMO communication. In this example, the performance graphs may be indicated based on parameters as shown in Table 1.

TABLE 1

| Parameter item | Parameter value |
|---|---|
| Number of APs (K) | 3 |
| Number of AP antennas | 4 |
| Number of user antennas | 2 and 4 |
| Noise variation | 1 |
| Number of streams for | 2 |
| each AP network | |
| Iterative number | 5, 10, 15, and 100 (ideal) |
| SNR range | 0~50 dB |

FIG. 6 illustrates a performance graph based on an environment of a 3-basic service set including a user terminal having four antennas.

In the performance graph, when an iteration is performed without restrictions on a number of times, a sum-rate may continuously increase according to an increase in a signal-to-noise ratio (SNR). When an iterative IA is applied in practice, the communication system may not unlimitedly perform the iteration due to restrictions on a coherence time of a wireless channel and a frame overhead. Thus, a maximum throughput, for example, an achievable throughput, may be restricted.

When an antenna space is extended, a relatively high throughput may be achievable by performing the iteration a reduced number of times with reference to the performance graph of FIG. 6.

FIG. 7 illustrates a performance graph based on an environment of the 3-basic service set including a user terminal having two antennas.

When the user terminal includes two antennas, a perfect IA may not be performed. Also, a throughput saturation phenomenon may occur due to a remaining interference with reference to the performance graph of FIG. 7. In this example, the communication system may be capable of improving the throughput by controlling power based on the remaining interference.

According to an aspect of the present invention, it is possible to efficiently perform an IA in an environment of a DL MU-MIMO communication by updating a transmission beamforming vector based on interference of an inter-basic service set and interference of an intra-basic service set.

According to another aspect of the present invention, it is possible to efficiently perform an IA by controlling power of a transmission beamforming vector despite an environment factor, for example, a relatively great number of BSSs and a relatively small number of communication apparatuses or user terminals.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An interference alignment (IA) method comprising:
transmitting, to a user terminal, a transmission beamforming vector generated arbitrarily;
receiving, from the user terminal, a reception beamforming vector calculated to minimize interference based on the transmission beamforming vector; and
updating the transmission beamforming vector based on the reception beamforming vector.

2. The method of claim 1, wherein the updating comprises:
calculating a transmission beamforming vector space minimizing interference of an inter-basic service set based on the reception beamforming vector;
calculating a transmission beamforming matrix minimizing interference of an intra-basic service set, based on the reception beamforming vector; and
updating the transmission beamforming vector based on the transmission beamforming matrix and the transmission beamforming vector space.

3. The method of claim 2, wherein the calculating of the space comprises calculating the transmission beamforming vector space using eigenvectors corresponding to eigenvalues of an interference vector calculated based on the reception beamforming vector.

4. The method of claim 2, wherein the calculating of the transmission beamforming matrix comprises calculating the transmission beamforming matrix such that the transmission beamforming vector is removed in response to the transmission beamforming vector received and decoded by a user terminal unpaired with a communication apparatus transmitting the transmission beamforming vector.

5. The method of claim 1, wherein the receiving and the updating are iteratively performed a preset number of times or until the transmission beamforming vector or the reception beamforming vector converges.

6. The method of claim 1, further comprising:
controlling power of the transmission beamforming vector based on a leakage of interference (LIF) of the user terminal

7. The method of claim 6, wherein the controlling comprises increasing the power of the transmission beamforming vector in a case in which an interference level of the transmission beamforming vector is less than a preset threshold, or in a case in which a throughput efficiency of the transmission beamforming vector is greater than the preset threshold.

8. The method of claim 6, wherein the LIF is shared with another communication apparatus within a network by broadcasting, to the other communication apparatus, a level of interference occurring due to the transmission beamforming vector.

9. An interference alignment (IA) method comprising:
receiving a transmission beamforming vector from a communication apparatus;
updating a reception beamforming vector based on the transmission beamforming vector; and
transmitting the reception beamforming vector to the communication apparatus,
wherein the transmission beamforming vector is updated based on the reception beamforming vector.

10. The method of claim 9, wherein the transmission beamforming vector is updated based on a transmission beamforming vector space calculated based on the reception beamforming vector and minimizing interference of an inter-basic service set, and a transmission beamforming matrix calculated based on the reception beamforming vector and minimizing interference of an intra-basic service set.

11. A communication apparatus comprising:
a transmitter to transmit, to a user terminal, a transmission beamforming vector generated arbitrarily;
a receiver to receive, from the user terminal, a reception beamforming vector calculated to minimize interference based on the transmission beamforming vector; and
an updater to update the transmission beamforming vector based on the reception beamforming vector.

12. The apparatus of claim 11, wherein the updater comprises:
a first calculator to calculate a transmission beamforming vector space minimizing interference of an inter-basic service set based on the reception beamforming vector;
a second calculator to calculate a transmission beamforming matrix minimizing interference of an intra-basic service set based on the reception beamforming vector; and
a transmission beamforming vector unit to update the transmission beamforming vector based on the transmission beamforming matrix and the transmission beamforming vector space.

13. The apparatus of claim 12, wherein the first calculator calculates the transmission beamforming vector space using eigenvectors corresponding to eigenvalues of an interference vector calculated based on the reception beamforming vector.

14. The apparatus of claim 12, wherein the second calculator calculates the transmission beamforming matrix such that the transmission beamforming vector is removed in response to the transmission beamforming vector received and decoded by a user terminal unpaired with a communication apparatus transmitting the transmission beamforming vector.

15. The apparatus of claim 11 wherein the receiver and the updater iteratively perform functions a preset number of times or until the transmission beamforming vector or the reception beamforming vector converges.

16. The apparatus of claim 11, further comprising:
a power controller to control power of the transmission beamforming vector based on a leakage of interference (LIF) of the user terminal

17. The apparatus of claim 16, wherein the power controller increases the power of the transmission beamforming vector in a case in which an interference level of the transmission beamforming vector is less than a preset threshold, or in a case in which a throughput efficiency of the transmission beamforming vector is greater than the preset threshold.

18. The apparatus of claim 16, wherein the LIF is shared with another communication apparatus within a network by broadcasting, to the other communication apparatus, a level of interference occurring due to the transmission beamforming vector.
